(19) United States
(12) Patent Application Publication
(10) Pub. No.: US 2026/0086896 A1
(43) Pub. Date: Mar. 26, 2026

(54) SMART LOG ANALYTICS FOR LARGE-SCALE HIGH PERFORMANCE COMPUTING AND ARTIFICIAL INTELLIGENCE SYSTEMS

(71) Applicant: Hewlett Packard Enterprise Development LP, Spring, TX (US)

(72) Inventors: Nilakantan Mahadevan, Minneapolis, MN (US); Michael Stephen Woodacre, Winchester (GB)

(21) Appl. No.: 18/898,213

(22) Filed: Sep. 26, 2024

(51) Int. Cl. G06F 11/07; G06F 16/28

(52) U.S. Cl. CPC G06F 11/0793; G06F 11/0709; G06F 11/079; G06F 16/285

(57) ABSTRACT

A system obtain, from components operating jointly in a system, events information indicating a first set of events interpreted from log entries associated with the components and a second set of events returned from queries for standard events. The system classifies the events interpreted from log entries based on a hierarchy of the components. The system correlates two or more events based on a respective event classification and a predetermined time window covering an event time associated with a respective event. The event time is derived from the log entries. The system generates a visual representation indicating the correlated events. Responsive to the visual representation indicating an anomaly, the system allows corrective actions addressing the indicated anomaly.

### BACKGROUND

Large-scale systems, such as high-performance computing (HPC) and artificial intelligence (AI) systems, may include many sub-systems, e.g., storage infrastructure, network fabrics, host interfaces, centralized fabric managers (FMs), switches, and other controllers. Workloads in HPC and AI systems may be sensitive to events in the sub-systems and can impact the performance of jobs. Anomaly detection and root cause analysis often involve extracting and analyzing event information from the sub-systems. However, this event information may be distributed across the many sub-systems in multiple formats, e.g., host-level journal logs, FM console logs, external system logs, etc. Furthermore, relationships may exist between the multiple sub-systems, which can result in complex tracing to perform root cause analysis.

### BRIEF DESCRIPTION OF THE FIGURES

FIG. 1A illustrates a system overview, including sub-systems and logs, of an environment which facilitates smart log analytics for large-scale HPC and AI systems, in accordance with an aspect of the present application.

FIG. 1B illustrates an example component topology which facilitates smart log analytics for large-scale HPC and AI systems, in accordance with an aspect of the present application.

FIG. 2 illustrates a high-level flow which facilitates smart log analytics for large-scale HPC and AI systems, in accordance with an aspect of the present application.

FIG. 3A illustrates a diagram of the transformation of log entries to a standard format, in accordance with an aspect of the present application.

FIG. 3B illustrates a diagram of the transformation of log entries to relevant events, in accordance with an aspect of the present application.

FIG. 3C illustrates a decision tree used for event classification of log entries, in accordance with an aspect of the present application.

FIG. 4 illustrates an environment, including a log analytics system communicating with multiple entities, which facilitates smart log analytics for large-scale HPC and AI systems, in accordance with an aspect of the present application.

FIG. 5A illustrates an exemplary display screen depicting a visualization, including anomalies of applications running on a host, network interface controller (NIC), and hardware which exceed a certain threshold, in accordance with an aspect of the present application.

FIG. 5B illustrates an exemplary display screen depicting a visualization, including relevant time periods to consider for correlations of events based on changes in power consumption, in accordance with an aspect of the present application.

FIG. 5C illustrates an exemplary display screen depicting a visualization, including events associated with anomalies of applications running on a host and hardware, in accordance with an aspect of the present application.

FIG. 5D illustrates an exemplary display screen depicting a visualization, including log extraction from a fabric manager and fabric controller agents, in accordance with an aspect of the present application.

FIG. 5E illustrates an exemplary display screen depicting a visualization, including anomalies of applications running on a host and events related to a fabric link, in accordance with an aspect of the present application.

FIG. 5F illustrates an exemplary display screen depicting a visualization, including network drop events and link events, in accordance with an aspect of the present application.

FIGS. 6A and 6B present flowcharts illustrating a method which facilitates smart log analytics for large-scale HPC and AI systems, in accordance with an aspect of the present application.

FIG. 7 illustrates a computer system which facilitates smart log analytics for large-scale HPC and AI systems, in accordance with an aspect of the present application.

FIG. 8 illustrates a computer-readable medium which facilitates smart log analytics for large-scale HPC and AI systems, in accordance with an aspect of the present application.

In the figures, like reference numerals refer to the same figure elements.

### DETAILED DESCRIPTION

Aspects of the present application provide a smart analytics automation engine that: defines a relationship hierarchy between the sub-systems of an overall system; interprets log information from the sub-systems into event information; and classifies these events to derive correlation information between them. The described aspects may also generate a report or visual representation of the correlations, which may allow corrective actions to be taken to address an indicated anomaly.

Large-scale systems (e.g., HPC and AI systems) may include many sub-systems (e.g., storage infrastructure, network fabric, host interfaces, centralized fabric managers, switches, and other controllers). Workloads in such large-scale systems may be sensitive to events in the sub-systems, which can impact the performance of jobs running across the sub-systems. Identifying relevant events and anomalies across the many sub-systems and components may require extracting and analyzing event information distributed in multiple formats across many sub-systems, e.g., host-level journal logs, fabric manager console logs, fabric controller agents console logs, external system logs, etc. Furthermore, relationships may exist between the multiple sub-systems, which can result in complex tracing to perform root cause analysis.

Extracting and analyzing event information distributed in multiple formats across many sub-systems may be performed by individually tailored programs. However, such a solution may be cumbersome in time and computational cost. In addition, analyzing relationships between sub-systems may involve complex tasks. For example, the reliability service of a high-speed NIC may be logging events which are symptoms to a problem and not the problem itself. Reported timeouts may affect the performance of jobs which may be caused by other factors, such as failure of a network interface in a different host or link errors in fabric links. Thus, analyzing the relationships between sub-systems given the complex tasks may be a limitation in efficiently identifying the root cause of various observed anomalous behavior.

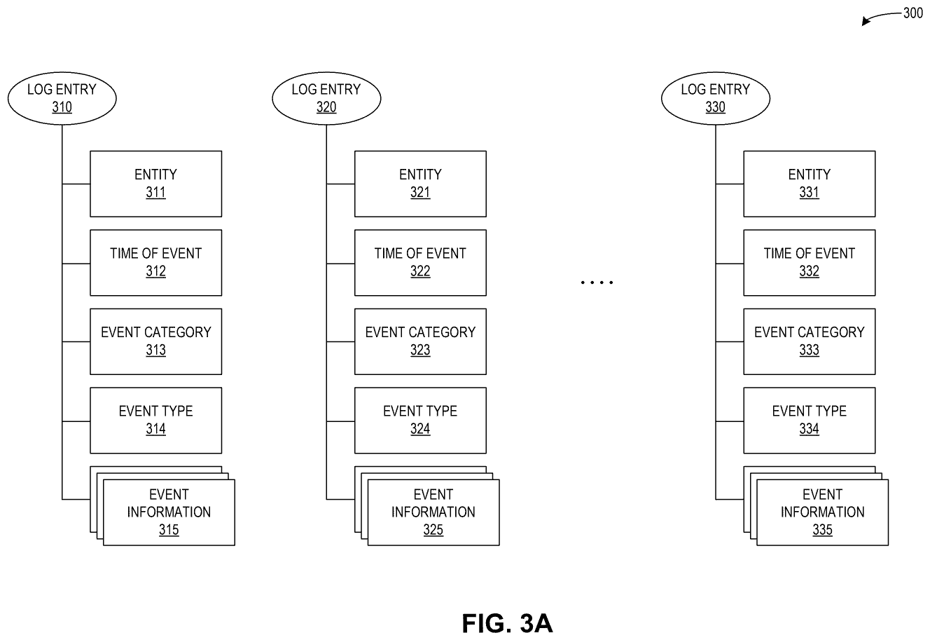

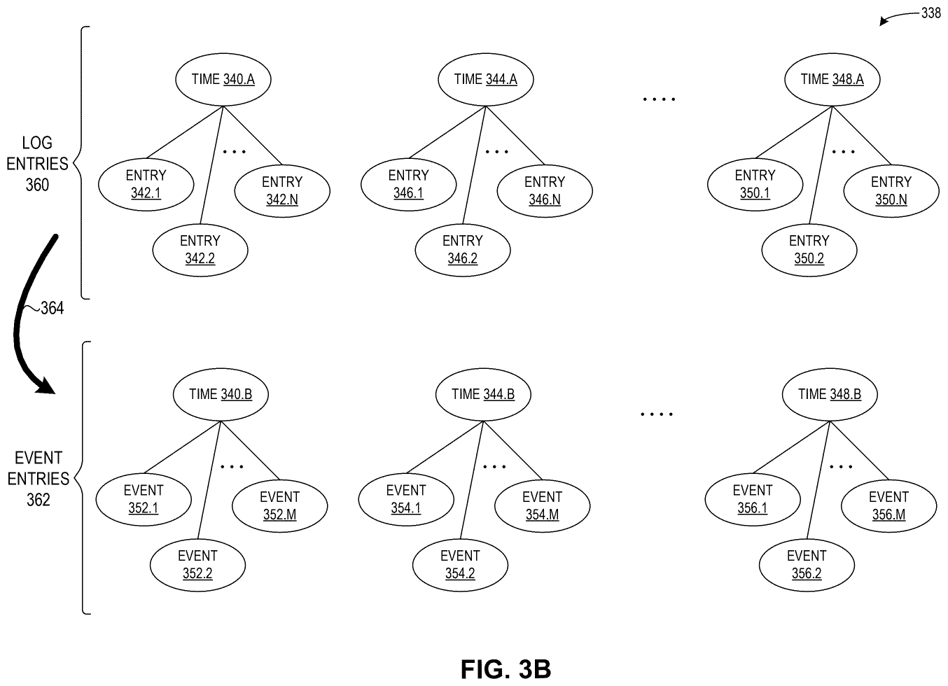

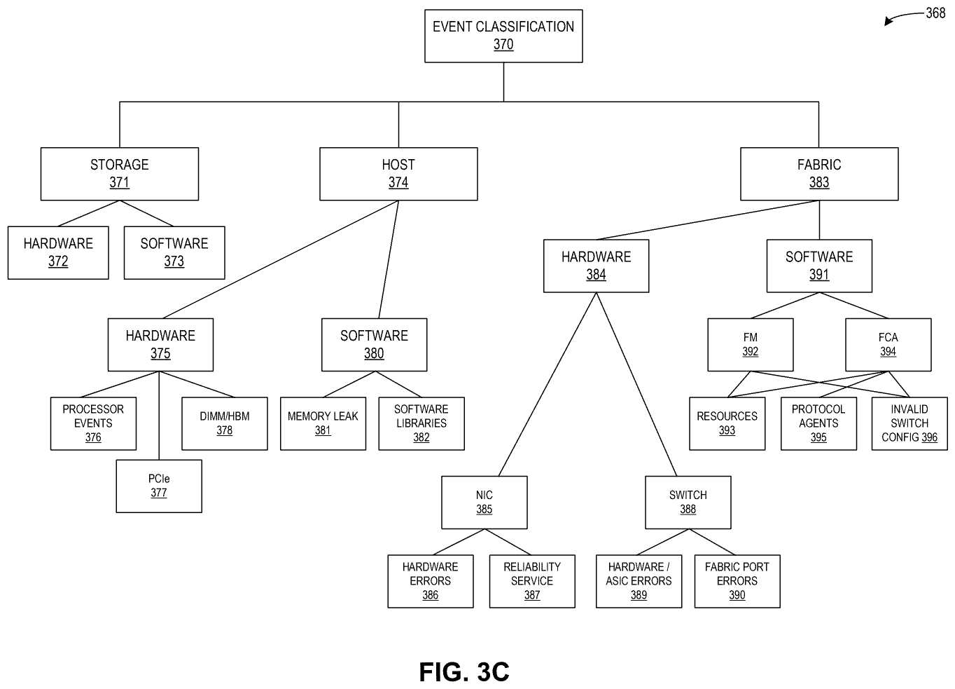

The described aspects address these limitations by providing a system which extracts, filters, and formats logs from multiple sub-systems and subsequently transforms the logs into events. The system may also classify the events based on a relationship hierarchy (e.g., a decision tree as described below in relation to FIG. 3C) and may further correlate two or more events based on the classification and a certain tine window associated with the respective events. The described aspects may also generate a report or visual representation of the correlations, which may result in interactive user feedback, e.g., allowing a user to perform a corrective action to address an indicated anomaly.

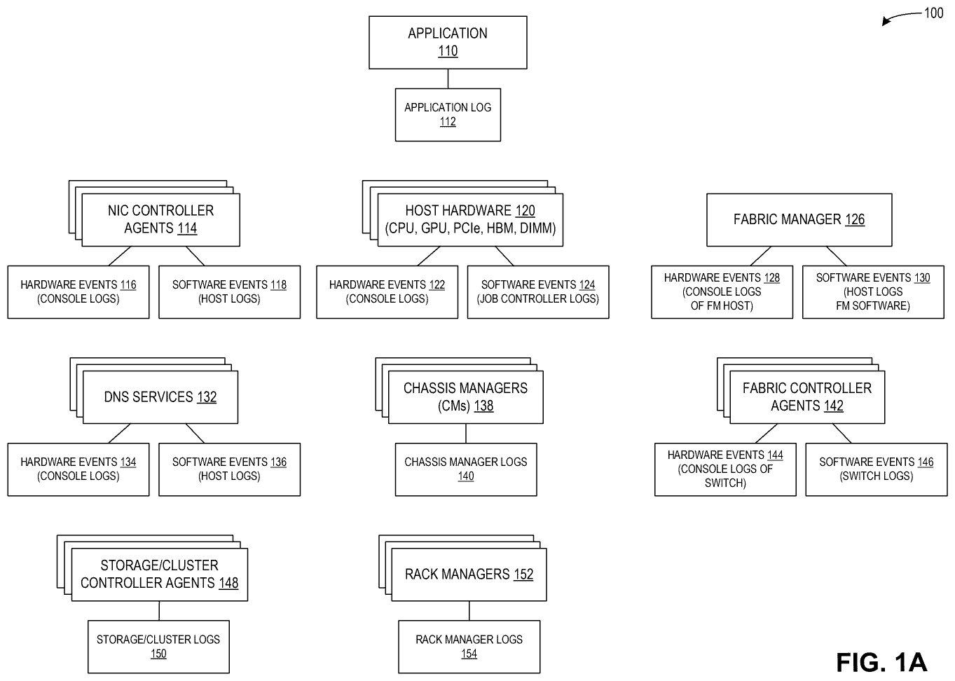

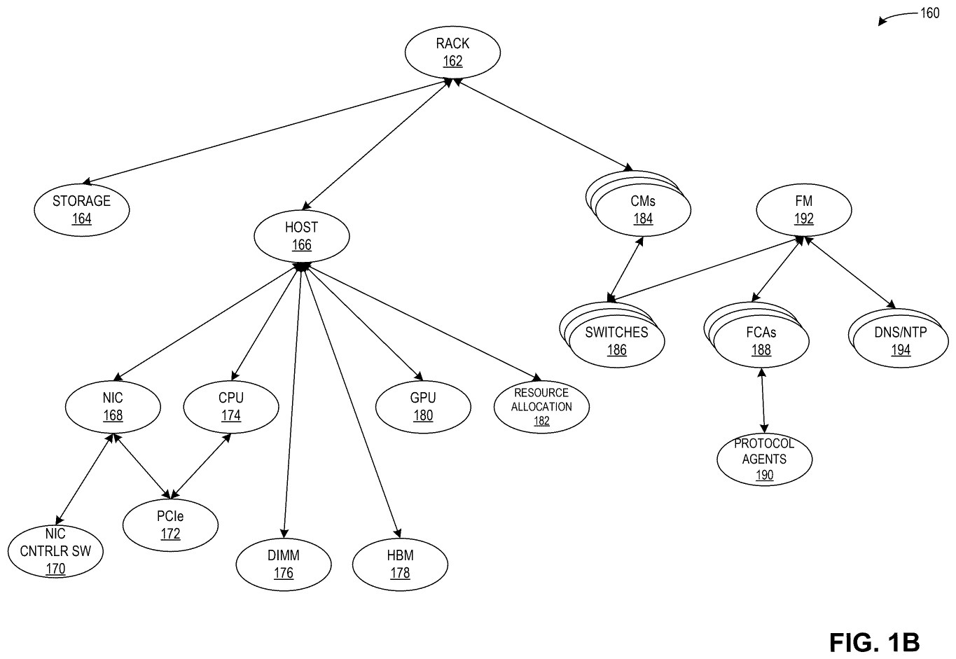

FIG. 1A illustrates an environment 100, including sub-systems and logs, of an environment which facilitates smart log analytics for large-scale HPC and AI systems, in accordance with an aspect of the present application. Environment 100 can be a large-scale HPC or AI system with multiple sub-systems, where each sub-system logs events in their own logs during operation. For example, an application 110 may log events in an application log 112. NIC controller agents 114 may log hardware events 116 in console logs and software events 118 in host logs. Host hardware 120 may include a central processing unit (CPU), a general processing unit (GPU), a peripheral component interconnect express (PCIe) unit, a high bandwidth memory (HBM) processor, and a dual in-line memory module (DIMM). Host hardware 120 may log hardware events 122 in console logs and software events 124 in job controller logs. A fabric manager (FM) 126 may log hardware events 118 in console logs of a fabric manager host and software events 130 in host logs of the fabric manager host. Domain Name Server (DNS) services 132 may log hardware events 134 in console logs and software events 136 in host logs. Chassis managers (CMs) 138 may log events in chassis manager logs 140. Fabric controller agents (FCAs) 142 may log hardware events 144 in console logs of a switch and software events 146 in switch logs. Storage/cluster controller agents 148 may log events in storage/cluster logs 150. Rack managers 152 may log events in rack manager logs 154. The sub-systems and logs depicted in environment 100 are non-limiting and provided for illustrative purposes only. Other sub-systems, components, units, and modules may create other logs based on hardware, firmware, software, or a combination.

FIG. 1B illustrates an example component topology 160 which facilitates smart log analytics for large-scale HPC and AI systems, in accordance with an aspect of the present application. In topology 160, a rack 162 may include storage (or cluster) 164, a host 166, and chassis managers (CMs) 184. Host 166 may include a NIC 168, a CPU 174, a DIMM 176, an HBM 178, a GPU 180, and a resource allocation (and application launcher services) 182. NIC 168 may interact based on NIC controller software 170 and PCIe 172. CPU 174 may also interact based on PCIe 172. CMs 184 may control or provide management services for switches 186. Fabric manager (FM) 192 may also provide management services for and interact with switches 186. FM 192 may also interact with fabric controller agents (FCAs) 188 and Domain Name Server/Network Time Protocol (DNS/NTP) 194. FCAs 188 may also interact with protocol agents 190. The organization of the elements (i.e., sub-systems) in topology 160 are non-limiting and provided for illustrative purposes only. Other topologies, elements (sub-systems), and relationships between elements may be part of a network topology.

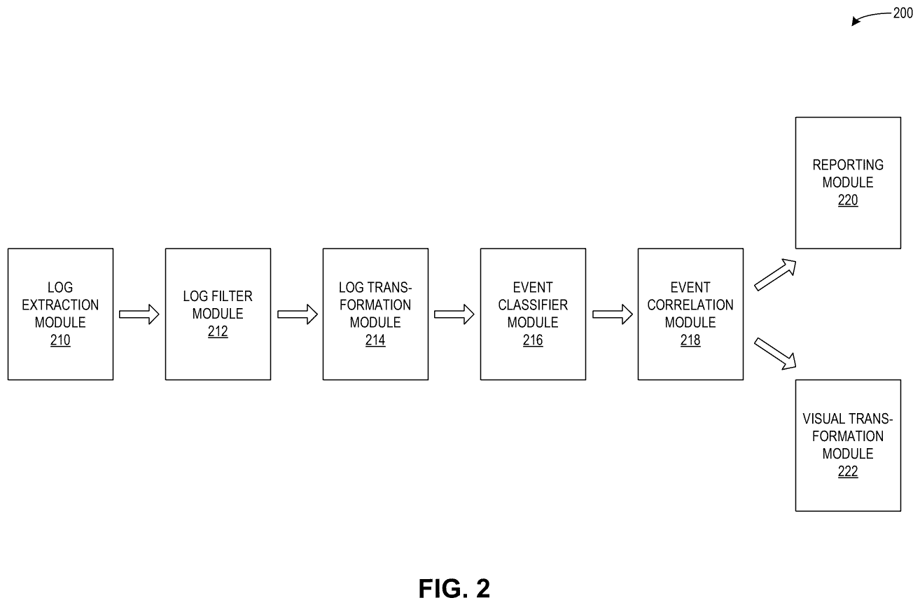

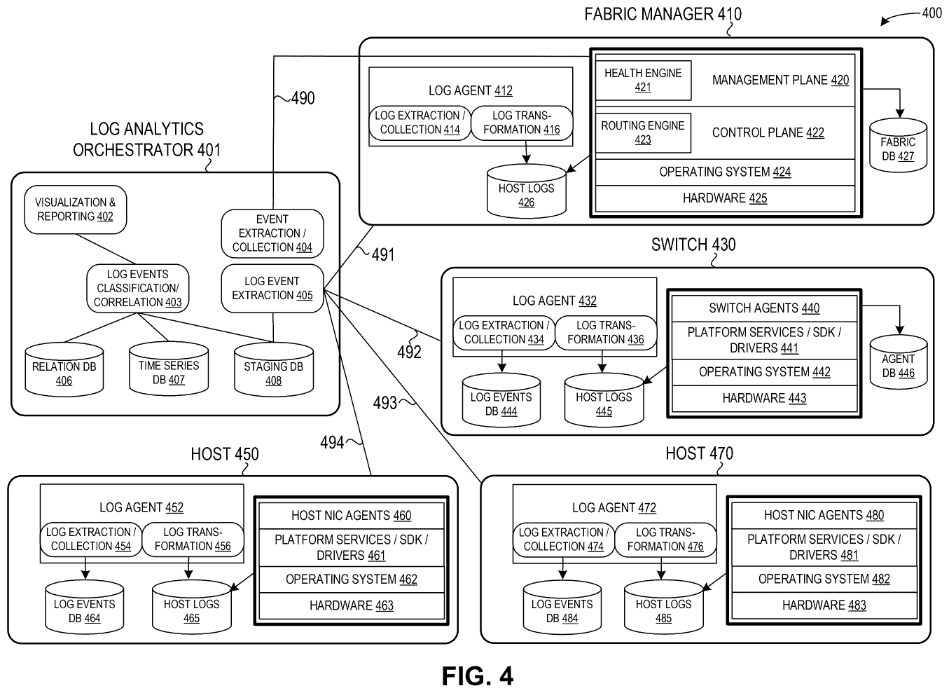

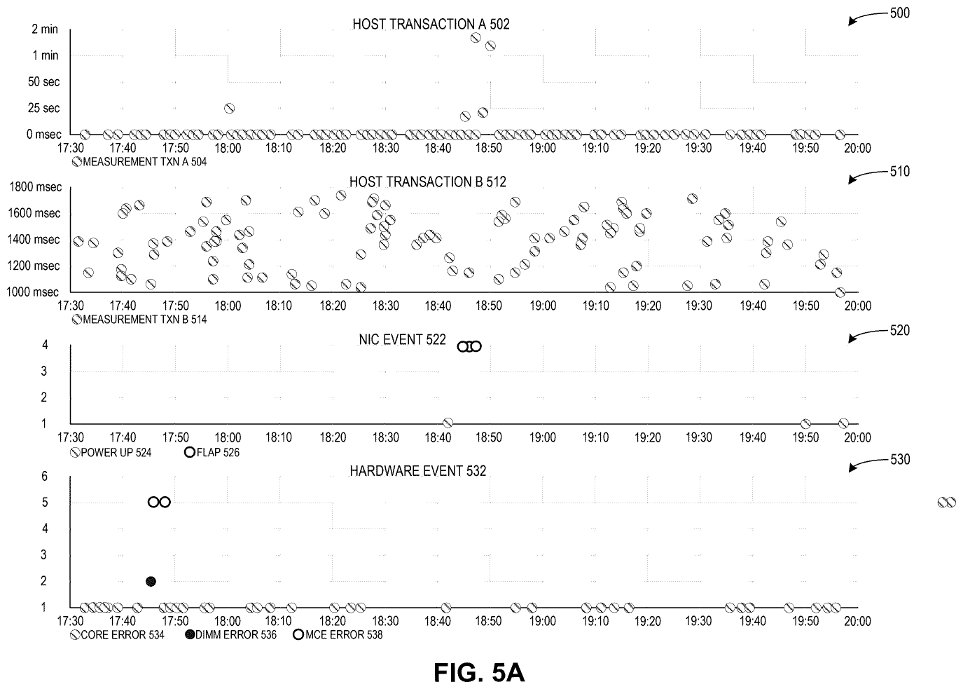

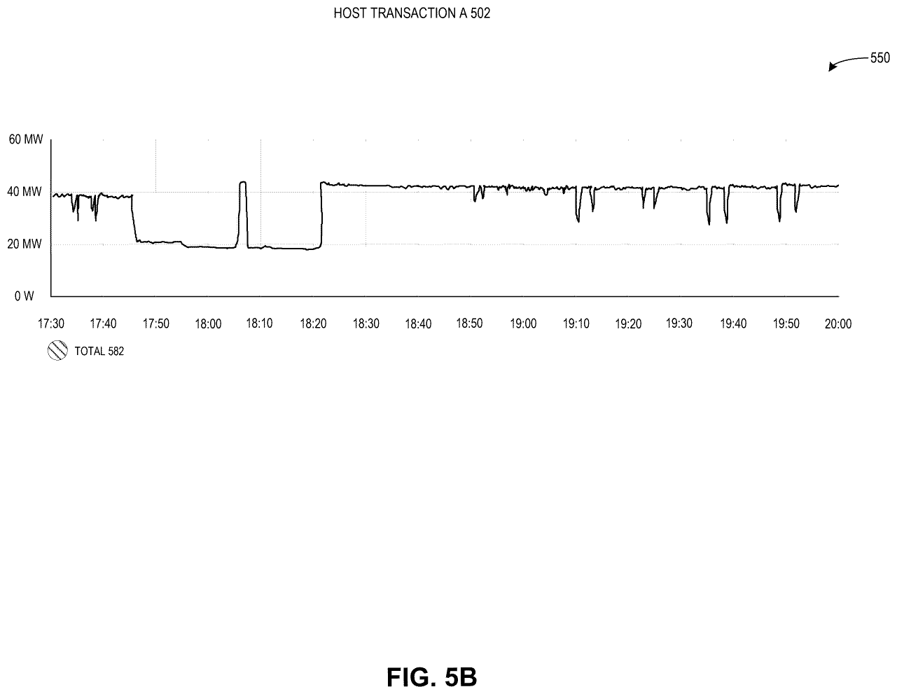

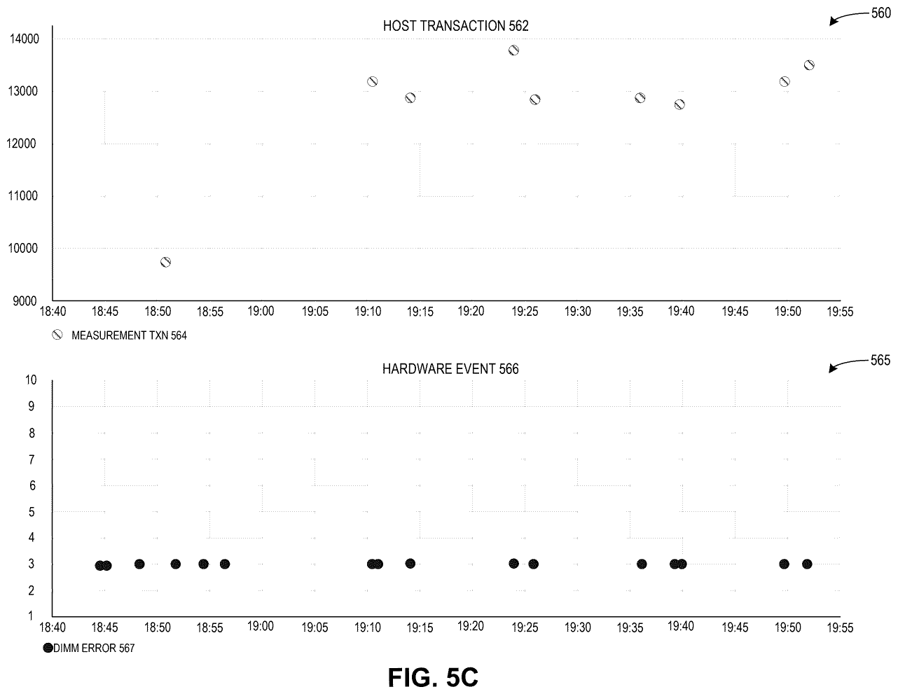

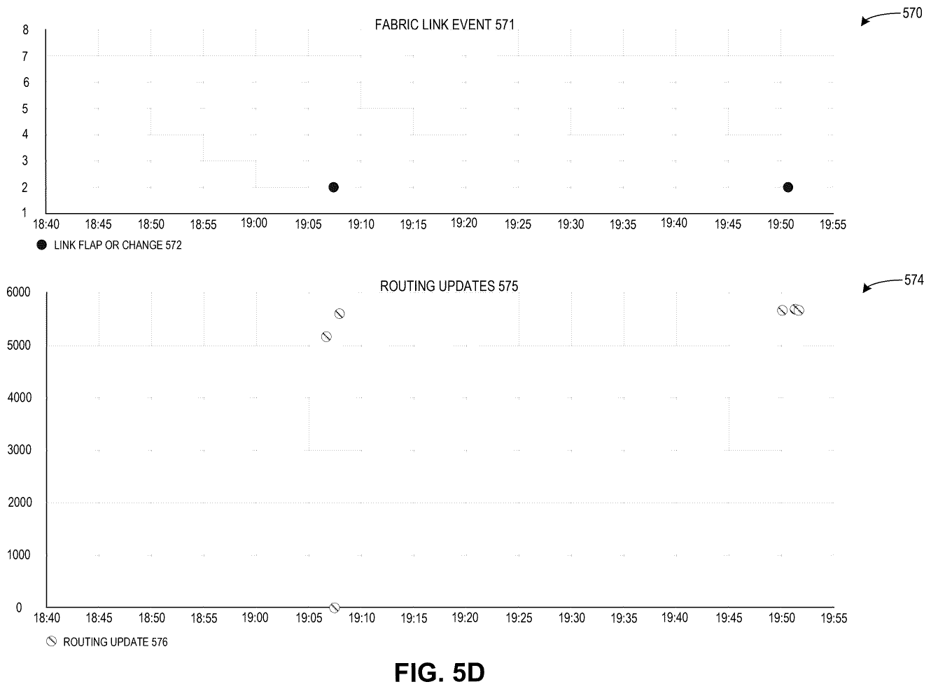

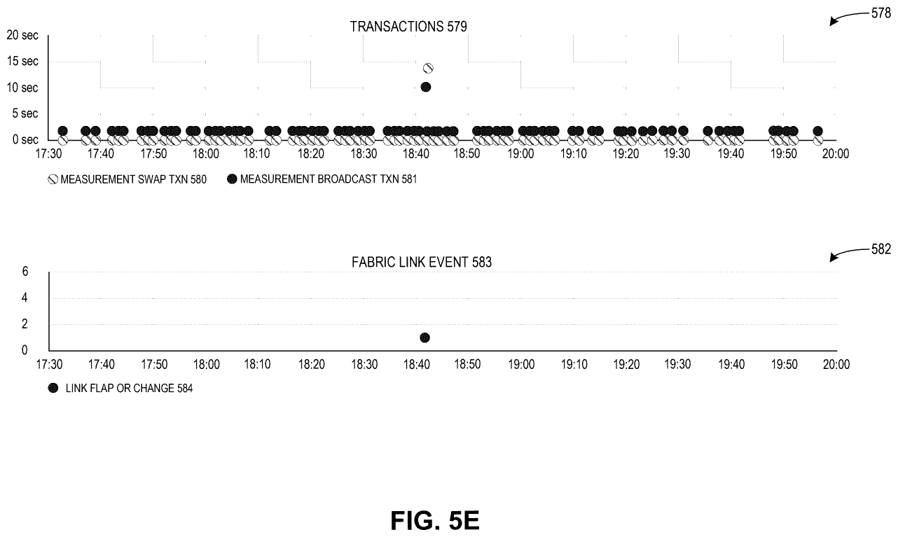

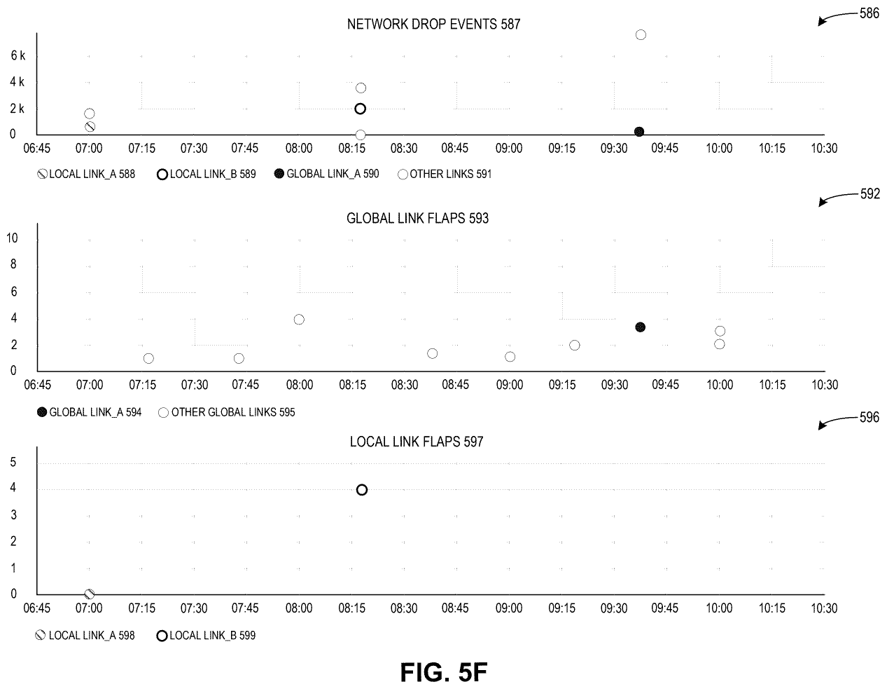

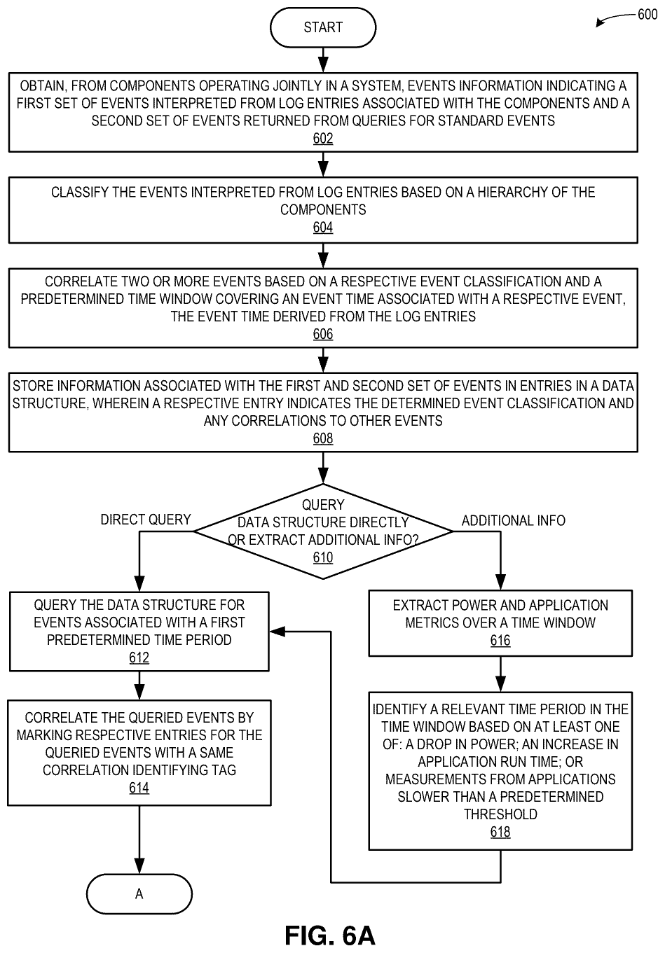

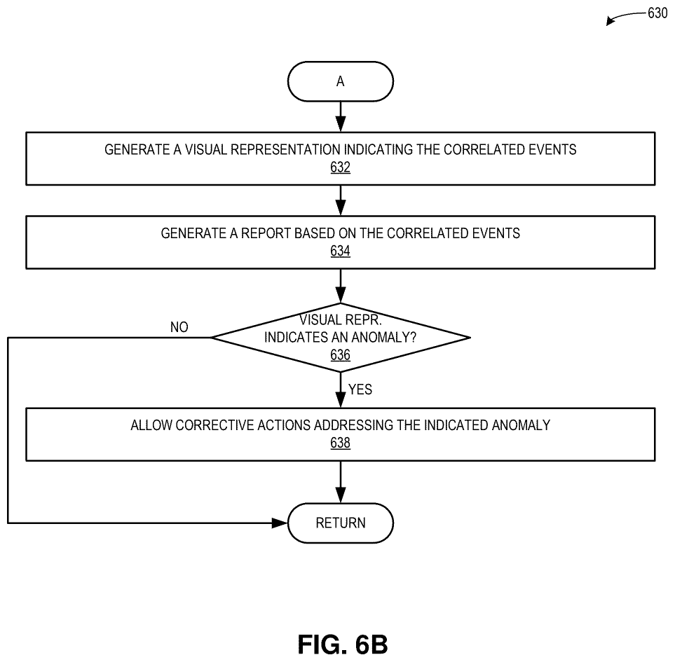

FIG. 2 illustrates a high-level flow 200 which facilitates smart log analytics for large-scale HPC and AI systems, in accordance with an aspect of the present application. During operation, the operations of modules 210, 212, and 214 may be performed by a log agent running in a specific component or sub-system (e.g., log agents 412, 432, 452, and 472 depicted below in FIG. 4), while the operations of modules 216, 218, 220, and 222 may be performed by a central orchestrator (e.g., log analytics orchestrator 401 depicted below in FIG. 4). A log extraction module 210 may include a log agent of a sub-system extracting various logs from components of the sub-system, e.g., host logs and console logs. A log filter module 212 may include a log agent eliminating noise in the extracted logs. A log transformation module 214 may include a log agent transforming the extracted and filtered log entries to event entries, as described below in relation to FIGS. 3A and 3B. An event classifier module 216 may include a central orchestrator classifying the events indicated in the transformed event entries, as described below in relation to FIGS. 6A and 6B. An event correlation module 218 may include a central orchestrator correlating the classified events based on a hierarchy of the components, as described below in relation to FIG. 3C. A reporting module 220 may include a central orchestrator generating a report based on the correlated events, as described below in relation to FIGS. 4 and 5A-F. A visual transformation module 222 may include a central orchestrator generating a visual representation indicating the correlated events, as described below in relation to FIGS. 5A-F. In addition, a user interaction module (not depicted) may include interactions of a user with information generated by reporting module 220 or visual transformation module 222, as described below in relation to FIGS. 5A-F.

FIG. 3A illustrates a diagram 300 of the transformation of log entries to a standard format, in accordance with an aspect of the present application. Diagram 300 depicts log entries 310, 320, and 330, which are all of a same standard format. For example, log entry 310 may include information relating to events, such as: an entity 311 corresponding to or associated with an event; a time of event 312 indicating a time at which the event occurred, such as a start time, an end time, or a time window; an event category 313 indicating, e.g., a level of severity of the event; an event type 314 indicating, e.g., a software event, hardware event, processor event, configuration event, or error event; and event information 315 indicating a description of the event and other related information. Similarly, log entry 320 may include: an entity 321; a time of event 322; an event category 323; an event type 324; and event information 325. In addition, log entry 330 may include: an entity 331; a time of event 332; an event category 333; an event type 334; and event information 335.

A log agent running on a sub-system may create the formatted log entries of diagram 300 based on the raw logs extracted from the various components of the sub-system. The log agent may further transform these formatted log entries, as described below in relation to FIG. 3B.

FIG. 3B illustrates a diagram 338 of the transformation of log entries to relevant events, in accordance with an aspect of the present application. Diagram 338 illustrates that log entries 360 may be transformed (as indicated by 364) to event entries 362 based on the event type (e.g., host, software, hardware, etc.) and by time format (e.g., a single time or a time window). For example, log entries which occur at a time 340.A (or within a time window defined by time 340.A) may include entries 342.1, 342.2 and 342.N. Similarly: log entries which occur at a time 344.A (or within a time window defined by time 344.A) may include entries 346.1, 346.2 and 346.N; and log entries which occur at a time 348.A (or within a time window defined by time 348.A) may include entries 350.1, 350.2 and 350.N.

A log agent running on a sub-system may transform log entries 360 to event entries 362, resulting in event entries clustered or grouped by a similar corresponding time. For example, log entries 342.1-N which are grouped to a time 340.A may be transformed to events 352.1, 352.2, and 352.M grouped to a time 340.B. Log entries 346.1-N which are grouped to a time 344.A may be transformed to events 354.1, 354.2, and 354.M grouped to a time 344.B. Log entries 350.1-N which are grouped to a time 348.A may be transformed to events 356.1, 356.2, and 356.M grouped to a time 348.B. The log agent may perform the transformation of a log entry to an event based on the event type information (e.g., as described above in relation to event type 314 of log entry 310 in FIG. 3A).

FIG. 3C illustrates a decision tree 368 used for event classification of log entries, in accordance with an aspect of the present application. As described above in relation to event classifier module 216 of FIG. 2, a central orchestrator may perform the event classification after obtaining the transformed event entries from the various log agents of the sub-systems. An event classification 370 may be related to storage 371, host 374, or fabric 383. If the event is a storage 371 event, then the classification may be hardware 372 or software 373. If the event is a host 374 event, then the classification may be: hardware 375, which may be further classified as processor events 376, PCIe events 377, or DIMM/HBM events 378; or software 380, which may be further classified as related to a memory leak 381 or software libraries 382. If the event is a fabric 383 event, then the classification may be hardware 384 or software 391. The fabric event hardware 384 may be further classified as related to: a NIC 385, which may be further classified as related to hardware errors 386 or reliability service 387; or a switch 388, which may be further classified as related to hardware/application-specific integrated circuit (ASIC) errors 389 or fabric port errors 390. The fabric event software 391 may be further classified as related to a fabric manager (FM) 392 or a fabric controller agent (FCA) 394. FM 392 may be further classified as related to resources 393 or an invalid switch configuration 396. FCA 394 may be further classified as related to resources 393, protocol agents 395, or invalid switch configuration 396.

The organization and elements depicted in decision tree 368 of FIG. 3C are non-limiting and provided for illustrative purposes only. Other decision tree topologies and element relationships may be used.

FIG. 4 illustrates an environment 400, including a log analytics orchestrator 401 communicating with multiple entities, which facilitates smart log analytics for large-scale HPC and AI systems, in accordance with an aspect of the present application. In environment 400, log analytics orchestrator 401 (also referred to as “orchestrator 401”) may communicate with multiple entities, including a fabric manager (FM) 410, a switch 430, and hosts 450 and 470. Each entity may include its own log agent which performs log extraction/collection of various logs generated and stored by a respective entity and which also performs log transformation to event entries. For example, FM 410 may include a log agent 412 which includes a log extraction/collection module 414 that obtains raw logs from, e.g., a fabric DB 427 or host logs 426. Log agent 412 may also include a log transformation module 416 which formats raw logs into log entries and event entries, as described above in relation to FIGS. 3A-B. Log agent 412 may store the transformed event entries in, e.g., host logs 426. The operations of log extraction/collection module 414 may correspond to module 210 of FIG. 2, and the operations of log transformation module 416 may correspond to module 214 of FIG. 2. FM 410 may also include: a management plane 420 with a health engine 421; a control plane 422 with a routing engine 423; an operating system 424; and hardware 425.

Switch 430 may include a log agent 432 which includes a log extraction/collection module 434 that obtains raw logs from, e.g., an agent DB 446 or host logs 445. Log agent 432 may also include a log transformation module 436 which formats raw logs into log entries and event entries, as described above in relation to FIGS. 3A-B. Log agent 432 may store the extracted/collected logs in log events DB 444 and may further store the transformed event entries in, e.g., host logs 445. Switch 430 may also include: switch agents 440; platform services/software development kit (SDK)/drivers 441; an operating system 442; and hardware 443.

Host 450 may include a log agent 452 which includes a log extraction/collection module 454 that obtains raw logs from, e.g., host logs 465. Log agent 452 may also include a log transformation module 456 which formats raw logs into log entries and event entries, as described above in relation to FIGS. 3A-B. Log agent 452 may store the extracted/collected logs in log events DB 464 and may further store the transformed event entries in, e.g., host logs 465. Host 450 may also include: host NIC agents 460; platform services/SDK/drivers 461; an operating system 462; and hardware 463. Similarly, host 470 may include a log agent 472 which includes a log extraction/collection module 474 that obtains raw logs from, e.g., host logs 485. Log agent 472 may also include a log transformation module 476 which formats raw logs into log entries and event entries, as described above in relation to FIGS. 3A-B. Log agent 472 may store the extracted/collected logs in log events DB 484 and may further store the transformed event entries in, e.g., host logs 485. Host 470 may also include: host NIC agents 480; platform services/SDK/drivers 481; an operating system 482; and hardware 483.

Orchestrator 401 may include an event extraction/collection module 404 and a log event extraction module 405. Event extraction/collection module 404 may query multiple entities for logs which may be related to standard events tracked by a respective entity, e.g., via a communication 490 from module 404 to FM 410. While only communication 490 to FM 410 is depicted, module 404 may also query for standard events from the other entities. Log event extraction module 405 may communicate with log agents of the multiple entities to obtain the transformed event entries, e.g., via communications 491, 492, 493, and 494 with, respectively, log agent 412 of FM 410, log agent 432 of switch 430, log agent 452 of host 450, and log agent 472 of host 470.

Upon obtaining both the events returned from queries for standard event (e.g., via 490) and the events interpreted from log entries associated with the entities or components (e.g., via 491-494), orchestrator 401 may store the extracted data in one or more of relation database 406, time series database 407, or staging database 408. In some aspects, staging DB 408 may include the filtered, extracted, formatted, transformed event entries output by, e.g., the operations of module 214 in FIG. 2. Time series DB 407 may include the log entries and event entries grouped or clustered based on event type and time format (e.g., by a certain time or a time window). Relation DB 406 may include information which correlates two or more events based on their respective event classification and the event time. The system may also obtain power utilization of the components from the management software of each component over a period of time. Module 403 (or another module, not shown) may convert metrics relating to application run time and transaction results into time series data and store that data in DB 407 along with the obtained power utilization. The system may use the data stored in any of relation DB 406, time series 407, and staging DB 408 for determining correlations and identifying relevant time periods of anomalous measurements or activity.

Upon classifying and correlating the events, a visualization and reporting module 402 of orchestrator 401 may generate reports and visualization. Example visualization of display screens is provided below in relation to FIGS. 5A-F. The operations of log events classification/correlation module 403 may correspond to modules 216 and 218 of FIG. 2, and the operations of visualization and reporting module 402 may correspond to, respectively, modules 222 and 220 of FIG. 2.

The entities, components, and sub-systems depicted in environment 400 of FIG. 4 are non-limiting and provided for illustrative purposes only. Other entities and relationships may be used. For example, the functionality of orchestrator 401 may reside in a single computing device, be accessible via a cloud computing environment, or be distributed over multiple virtual or physical network devices or nodes in a networking environment. As another example, more or fewer elements or components may exist for each of the depicted entities (FM 410, switch 430, and hosts 450 and 470).

FIG. 5A illustrates an exemplary display screen depicting a visualization, including anomalies of applications running on a host, NIC, and hardware which exceed a certain threshold, in accordance with an aspect of the present application. Diagrams 500, 510, 520, and 530 in FIG. 5A illustrate a representation of application measurements that represent anomalies in a sample used for correlation of relevant transformed events from logs and standard events. A diagram 500 indicates measurements associated with a host event (e.g., host transaction A 502). A diagram 510 indicates measurements associated with a host event (e.g., host transaction B 512). A diagram 520 indicates measurements associated with a NIC event (e.g., NIC event 522). A diagram 530 indicates measurements associated with a hardware event (e.g., hardware event 532). In diagrams 500, 510, 520, and 530, the x-axis indicates time in ten-minute increments from 17:30 to 20:00. In diagram 500, the y-axis indicates an amount of time in seconds and minutes. In diagram 510, the y-axis indicates an amount of time in milliseconds. In diagrams 520 and 530, the y-axis indicates a number of errors (e.g., an error count at a given time).

A user may view the visualization of the measurements of events from various entities based on the transformed log entries of the orchestrator. A visual inspection of the displayed information may allow the user to quickly identify and remediate a correlated problem.

In diagram 500, the partially shaded dots correspond to a measurement of transaction A (504) as taken at a given time. Most of the measurements occur on the 0 msec line, which indicates that most are below a certain expected threshold. However, diagram 500 also indicates occurrences of transaction A which take a much longer time than the threshold at times 18:00 and between 18:45 and 18:50.

In diagram 510, the partially shaded dots correspond to a measurement of transaction B (514) as taken at a given time. Most of the measurements occur in a fairly distributed fashion in the range between 1000 and 1800 milliseconds for the indicated time period. No unusual or anomalous activity appears immediately discernible from diagram 510.

In diagram 520, the dots correspond to a count of various NIC-related events (522). The partially shaded dots correspond to power-up events (524) and the bold-lined dots correspond to flapping events (526). Diagram 520 indicates that three occurrences of the NIC flapping occur between 18:45 and 18:50, which is the same time period during which the anomalous host transaction A measurements also occurred (as depicted in diagram 500). As a result, a user may determine an anomaly in the events of, and therefore a correlation between, host transaction A and the flapping of the NIC. The user may perform a corrective action to address the anomaly, e.g., restart or replace the NIC.

In diagram 530, the dots correspond to a count of various hardware-related events (532). The partially shaded dots correspond to core error events (534), the solid-colored dots correspond to DIMM error events (536), and the bold-lined dots correspond to machine check exception (MCE) error events (538). Diagram 530 indicates that two MCE errors occur between 17:45 and 17:50, and diagram 510 indicates that a few anomalous occurrences of host transaction B measurements also occur between the same time window. As a result, a user may determine an anomaly in the event of, and therefore a correlation between, host transaction B and the MCE errors detected in the hardware. The user may perform a corrective action to address the anomaly, e.g., isolate or remove the node in which the MCE errors are detected.

The system may also generate a report (not depicted) which may indicate the detected anomaly or correlation and suggest a corrective action to be taken by the user in order to address the anomaly. The report and the visualization may include one or more interactive elements which facilitate viewing or manipulating the displayed information (whether in the report or the visualization). The interactive elements may be related to, e.g.: the detected anomaly; a recommended action indicating remediation of the detected anomaly; or a configurable option indicating that the system is to automatically perform the recommended action. In some aspects, the system may provide configurable or selectable default options at startup relating to when to take a recommended option, a type of automated action approved by the user, a duration of time for which an approval of an automated action may be given, etc.

FIG. 5B illustrates an exemplary display screen depicting a visualization, including relevant time periods to consider for correlations of events based on changes in power consumption, in accordance with an aspect of the present application. A diagram 550 indicates power measurements (y-axis in megawatts (MW)) over time (x-axis of time labeled in ten minute increments from 17:30 to 20:00). Diagram 550 indicates a significant power spike around 18:06. Used in conjunction with other visualizations of, e.g., anomalies of applications running on a host, NIC, or hardware, a user may determine that a certain event or events occurring around that same time may be correlated with the power spike indicated in diagram 550. The user may perform a corrective action to investigate or address the reason for the power spike based on the visual representations generated by the system. For example, a user may observe patterns between the diagrams in FIG. 5A (i.e., 500, 510, 520, and 530) and diagram 550 of FIG. 5B. A drop or spike in the power curve which occurs at a similar time period as anomalies in the application may determine a relevant time period for further analysis. Several anomalous measurements appear related to host transaction B 512 in diagram 510 between 18:00 and 18:10. During the same time period, the power curve in diagram 550 indicates a power spike (between 18:00 and 18:10). Based on the visual representations, the user (or system) may correlate the events and perform a corrective action to further investigate the correlation between the anomalous measurements for host transaction B 512 and the power curve of diagram 550 occurring in this relevant time period, e.g., the time period between 18:00 and 18:10. The user may also further investigate other actions which may occur during this identified relevant time period.

FIG. 5C illustrates an exemplary display screen depicting a visualization, including events associated with anomalies of applications running on a host and hardware, in accordance with an aspect of the present application. A diagram 560 indicates measurements associated with a host event (e.g., host transaction 562). In diagrams 560 and 565, the x-axis indicates time in five-minute increments from 18:40 to 19:55. In diagram 560, the y-axis indicates an amount of time in milliseconds. In diagram 565, the y-axis indicates a number of errors (e.g., an error count at a given time).

In diagram 560, the partially shaded dots correspond to a measurement of the host transaction (564) as taken at a given time. In diagram 560, transaction measurements greater than 1000 milliseconds may be considered anomalies. For example, several anomalous measurements occur between 19:10 and 19:53. In diagram 565, the solid-colored dots correspond to DIMM error events (567). The same number of DIMM errors occurs repeatedly throughout the measured time period, including in groups of occurrences which align with the anomalous occurrences of host transaction 562, e.g., around 19:10 and 19:14, 19:45 and 19:26, 19:36 and 19:39, and 19:50 and 19:52. The DIMM errors (567) which occur consistently from a particular node may be correlated with the corresponding anomalous measurements for the host transaction (564). As a result, a user may perform a corrective action to address the anomaly, e.g., abort the jobs associated with the host transaction and take further action.

FIG. 5D illustrates an exemplary display screen depicting a visualization, including log extraction from a fabric manager and fabric controller agents, in accordance with an aspect of the present application. A diagram 570 indicates measurements associated with a fabric link event 571 and a diagram 574 indicates routing updates 575. In diagrams 570 and 574, the x-axis indicates time in five-minute increments from 18:40 to 19:55. In diagram 570, the y-axis indicates a number of fabric link events and the solid-colored dots represent link flaps or changes for a particular link (572). In diagram 574, the y-axis indicates routing updates and the partially shaded dots indicate routing updates at an indicated time (576). Based on FIG. 5D, a correlation may be made between the routing updates and the fabric link changes during the time periods around 19:08 and 19:51. The routing updates may be observed to be a result of fabric link changes, i.e., correlated events. Thus, times or time windows around these time periods may be relevant for detecting anomalies or anomalous activity.

FIG. 5E illustrates an exemplary display screen depicting a visualization, including anomalies of applications running on a host and events related to a fabric link, in accordance with an aspect of the present application. FIG. 5E depicts an example of log analysis from fabric controller agents used in conjunction with the application logs in order to correlate behavior.

In diagrams 578 and 582, the x-axis indicates time in ten-minute increments from 17:30 to 20:00. The data in diagrams 578 and 582 may be based on a sample high-performance benchmark run on thousands of nodes. Diagram 578 indicates measurements associated with transactions 579, where: the y-axis indicates an amount of time in seconds; the partially shaded dots indicate measurements for a swap transaction 580; and the solid-colored cots indicate measurements for a broadcast transaction 581. Diagram 582 indicates measurements associated with a fabric link event 583, where: the y-axis indicates a number of fabric link events; and the solid-colored dots represent link flaps or changes for a particular link (584). Based on FIG. 5E, a correlation may be made between certain transaction times and fabric events at the time period around 18:41. The fabric event (link flap or change 584) may result in high swap transaction (580) and broadcast transaction (581) times in the high-performance application at 18:41.

FIG. 5F illustrates an exemplary display screen depicting a visualization, including network drop events and link events, in accordance with an aspect of the present application. In diagrams 586, 592, and 596, the x-axis indicates time in 15-minute increments from 06:45 to 10:30. Local link_A and local link_B may represent local links in, e.g., a dragonfly topology, while global link_A may represent a global fabric link in, e.g., a dragonfly topology. The links described in FIG. 5F are used for illustrative purposes only. Other links and network topologies may be used. FIG. 5F depicts an example of the extraction of standard health events in addition to log extraction in order to determine a relevant time period (i.e., the predetermined time window) for detecting anomalous behavior.

Diagram 586 indicates measurements associated with network drop events 587, where: the y-axis indicates a number of drop events (e.g., a number of packets dropped); the partially shaded dots indicate drop events for a local fabric link (local link_A 588); the bold-outlined dots indicate drop events for a local fabric link (local link_B 589); the solid-colored dots indicate drop events for a global fabric link (global link_A 590); and the other dots indicate drop events for other link (other links 591).

Note that the other dots depicted as other links may represent separate local or global fabric links and are depicted with the same label in diagram 586 for purposes of illustration. Individual colors, labels, formatting, or other identifiers may be used to indicate each of the other separate local or global fabric links.

Diagram 592 indicates measurements associated with global link flap events 593, where: the y-axis indicates a number of links flaps (e.g., at a given time); the solid-colored dots represent link flaps for global link_A 594; and other dots represent link flaps for other global links 595. Diagram 596 indicates measurements associated with local link flap events 597, where: the y-axis indicates a number of link flaps (e.g., at a given time); the solid-colored dots represent link flaps for local link_A 598; and the bold-outlined dots represent link flaps for local link_B 599.

Based on FIG. 5F, a correlation may be made between packets dropped in the fabric and link flaps at different levels (i.e., local link_A, local link_B, and global link_A). For example, at around 07:00, a link flap for local link_A (as depicted in diagram 596) may result in the network packet drops depicted at the same time for local link_A (as depicted in diagram 586). Similarly, at around 08:17, a link flap for local link_B (as depicted in diagram 596) may result in the network packet drops depicted at the same time for local link_B (as depicted in diagram 586). In addition, at around 09:38, a link flap for global link_A (as depicted in diagram 592) may result in the network packet drops depicted at the same time for global link_A (as depicted in diagram 586).

FIGS. 6A and 6B present flowcharts 600 and 630 illustrating a method which facilitates smart log analytics for large-scale HPC and AI systems, in accordance with an aspect of the present application. During operation, the system obtains, from components operating jointly in a system, events information indicating a first set of events interpreted from log entries associated with the components and a second set of events returned from queries for standard events (operation 602). Log agents running on various components may generate the log entries indicating the first set of events by extracting logs from one or more of the components in the system, as described above in relation to the log extraction/collection modules 414, 434, 454, and 474 of, respectively, log agents 412, 432, 452, and 472 of FIG. 4 as well as log extraction module 210 of FIG. 2. The log agents may remove noise in the extracted logs by filtering the extracted logs and may also obtain re-formatted log entries by re-formatting the filtered logs. For example, the log entries 310, 320, and 330 of FIG. 3A may be obtained after the above-described filtering and re-formatting (also as described above in relation to log filter module 212 of FIG. 2). The log agents may generate event information based on characteristics of the re-formatted log entries, as described above in relation to event information 315, 325, and 335 of FIG. 3A.

The system classifies the events interpreted from log entries based on a hierarchy of the components (operation 604). For example, log analytics orchestrator 401 of FIG. 4 may use a decision tree such as the one depicted above in relation to FIG. 3C.

The system correlates two or more events based on a respective event classification and a predetermined time window covering an event time associated with a respective event, the event time derived from the log entries (operation 606). The predetermined time window may be determined from measurements relating to power consumption, application run time, and transaction results associated with the components. For example, for a given time window, two or more events with a respective classification and which occur during a same time window may be correlated, as described above in relation to the NIC flapping errors (526) in NIC event 522 and the anomalous measurements (504) of host transaction A 502 in the visual representations of FIG. 5A, as well as the examples described above in FIGS. 5B-5F.

The system stores information associated with the first and second sets of events in entries in a data structure, wherein a respective entry indicates the determined event classification and any correlations to other events (operation 608). The system may store the information prior to classifying the events or correlating the events (as in, respectively, operations 604 and 606). The information may be stored in a format similar to the one described above for log entries 310, 320, and 330 in FIG. 3A. The system may store these entries in a time series database, such as time series database 407 of log analytics orchestrator 401 in FIG. 4.

The system determines whether to query the data structure directly or to extract additional information (decision 610). The system may make this determination based on a configuration previously set which indicates whether additional information, e.g., relating to power metrics, is to be used in determining the first predetermined time period or identifying the relevant time period. If the system determines to query the data structure directly (decision 610), the system queries the data structure for events associated with a first predetermined time period (operation 612). The first predetermined time period may be based on measurements relating to power draw, application run time, and transaction results associated with the components. The system correlates the queried events by marking respective entries for the queried events with a same correlation identifying tag (operation 614). The system may also correlate the queried events by linking entries together using pointers or other relational operations. The operation continues at Label A of FIG. 6B.

If the system determines to extract additional information (decision 610), the system extracts power and application metrics over a time window (operation 616), e.g., power utilization and application metrics associated with the components in the system during a certain time window that may identify relevant time periods with anomalous measurements, as described above in relation to module 403 of log analytics orchestrator 401 of FIG. 4. The system identifies a relevant time period in the time window based on, e.g.: a drop in power; an increase in application run time; or slow measurements from applications (e.g., slower than a predetermined threshold) (operation 618). The factors listed herein as a basis for identifying a relevant time period are provided for illustrative purposes only. Other factors may be used. The system may use the identified relevant time period as the first predetermined time period and the operation continues at operation 610.

FIG. 6B depicts a continuation of the operations from FIG. 6A subsequent to operation 614. The system generates a visual representation indicating the correlated events (operation 632). The visual representation may indicate the correlated events and the correlated queried events (from operation 612). The visual representation may include diagrams which indicate a measurement (such as an amount of time or a number of errors) over a period of time, e.g., as in the diagrams of FIGS. 5A-5F. The system generates a report based on the correlated events (operation 634). The system may display the report, and the report may include one or more interactive elements which facilitate viewing or manipulating the displayed information, including but not limited to, e.g.: a detected anomaly; a recommended action indicating remediation of the detected anomaly; or a configurable option indicating that the computer is to automatically perform the recommended action. The system may further perform a first action based on the displayed report. The first action may be a corrective action performed by a user associated with the system or the first action may be an action automatically performed by the system based on previously configured options for automatically accepting or executing recommended actions.

If the visual representation does not indicate an anomaly (decision 636), the operation returns. If the visual representation indicates an anomaly (decision 636), the system allows corrective actions addressing the indicated anomaly (operation 638). For example, in response to diagrams 500 and 520 indicating an anomaly based on the displayed measurements and correlated events, a user may perform a corrective action to address the indicated anomaly, e.g., by restarting a NIC, removing a job or pausing a host transaction, removing or replacing a node or other hardware component, etc. In some aspects, operations 616 and 618 may be performed by a user in response to viewing the generated visual representation or report. That is, by viewing the visual representation or report, the user may identify a relevant time period in a certain time window based on extracted and displayed power and application metrics. The user (or the system) may query the data structure for events in the identified relevant time period and correlate the queried events (as described above in relation to operations 612 and 614 of FIG. 6A). In addition, the user may perform a corrective action based on the displayed reported (generated in operation 634, as described above), e.g., based on a recommended action indicating remediation of a detected anomaly. For example, the user may replace a NIC which is identified as correlated to anomalous activity in a host transaction. The system may also perform other corrective actions, including inputting information associated with the correlated events into an external system in order to train a machine learning model. Anomalous activity or anomalies may be depicted in the visual representation when measurements for a respective event are greater than a predetermined benchmark or other threshold.

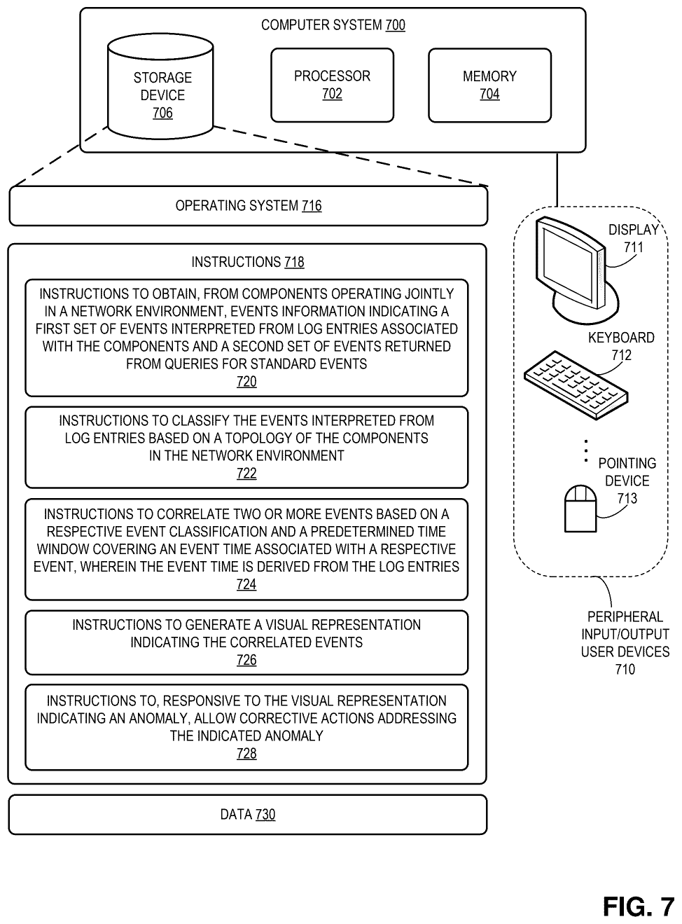

FIG. 7 illustrates a computer system 700 which facilitates smart log analytics for large-scale HPC and AI systems, in accordance with an aspect of the present application. Computer system 700 includes a processor 702, a memory 704, and a storage device 706. Memory 704 may include a volatile memory (e.g., random access memory (RAM)) that serves as a managed memory and can be used to store one or more memory pools. Furthermore, computer system 700 may be coupled to peripheral I/O user devices 710 (e.g., a display device 711, a keyboard 712, and a pointing device 713). Storage device 706 includes non-transitory computer-readable storage medium and stores an operating system 716, instructions 718, and data 730. Computer system 700 may include fewer or more entities or instructions than those shown in FIG. 7.

Instructions 718 can include instructions, which when executed by computer system 700, may cause computer system 700 to perform methods and/or processes described in this disclosure. Specifically, instructions 718 may include instructions 720 to obtain, from components operating jointly in a network environment, events information indicating a first set of events interpreted from log entries associated with the components and a second set of events returned from queries for standard events, as described above in relation to operation 602 of FIG. 6A and log entries 310, 320, and 330 of FIG. 3A.

Instructions 718 may include instructions 722 to classify the events interpreted from log entries based on a topology of the components in the network environment, as described above in relation to event classifier module 216 of FIG. 2, decision tree 368 of FIG. 3C, and operation 604 of FIG. 6A.

Instructions 718 may include instructions 724 to correlate two or more events based on a respective event classification and a predetermined time window covering an event time associated with a respective event, wherein the event time is derived from the log entries and wherein the predetermined time window is determined from measurements relating to power consumption, application run time, and transaction results associated with the components, as described above in relation to operation 604 of FIG. 6A and the diagrams of FIGS. 5A-F.

Instructions 718 may include instructions 726 to generate a visual representation (and a report) indicating the correlated events, as described above in relation to operations 632/634 and decision 636 of FIG. 6B and the diagrams of FIGS. 5A-F.

Instructions 718 may include instructions 728 to, responsive to the visual representation indicating an anomaly, allow corrective actions addressing the indicated anomaly, as described above in relation to the operations of FIG. 6B.

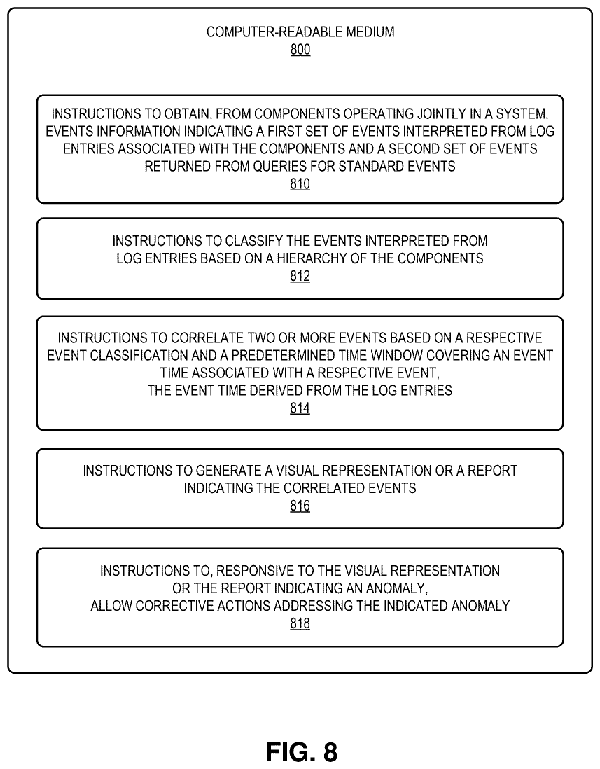

Instructions 718 may include more instructions than those shown in FIG. 7. For example, instructions 718 may include instructions for executing the operations described above in relation to: the high-level flow of FIG. 2; the log entry collection, formatting, transformation, and classification of FIGS. 3A-C; the environment and communications of FIG. 4; the diagrams of FIGS. 5A-F; the operations depicted in the flowcharts of FIGS. 6A and 6B; and the instructions of CRM 800 in FIG. 8.

Data 730 can include any data that is required as input or that is generated as output by the methods, operations, communications, and/or processes described in this disclosure. Specifically, data 730 may store at least: event information; an entry; a first set of event interpreted from log entries; a second set of events returned from queries for standard events; a classification; an event classification; a correlation between two or more events; a time window; an event time; a visual representation; a report; an indicator of an anomaly; an indicator or identifier of hardware, software, or other component in a system or associated with storage components, host components, or fabric components in the system; raw logs or log data; an extracted log; noise; a filtered log; a re-formatted log entry; a characteristic of a log entry; an identity of an entity or component; a time; an event category; an event type; an event description; a data structure; information; correlated events or correlated queried events; a report; an indicator or recommendation of an action or corrective action; and an interactive element facilitating viewing or manipulating displayed information including a detected anomaly, a recommended action, and a configurable option.

FIG. 8 illustrates a computer-readable medium (CRM) 800 which facilitates smart log analytics for large-scale HPC and AI systems, in accordance with an aspect of the present application. CRM 800 can be a non-transitory computer-readable medium or device storing instructions that when executed by a computer or processor cause the computer or processor to perform a method. CRM 800 may store instructions 810 to obtain, from components operating jointly in a system, events information indicating a first set of events interpreted from log entries associated with the components and a second set of events returned from queries for standard events, as described above in relation to operation 602 of FIG. 6A and log entries 310, 320, and 330 of FIG. 3A.

CRM 800 may store instructions 812 to classify the events interpreted from log entries based on a hierarchy of the components, as described above in relation to event classifier module 216 of FIG. 2 and operation 604 of FIG. 6A.

CRM 800 may store instructions 814 to correlate two or more events based on a respective event classification and a predetermined time window covering an event time associated with a respective event, the event time derived from the log entries and the predetermined time window determined from measurements relating to power consumption, application run time, and transaction results associated with the components, as described above in relation to operation 604 of FIG. 6 and the diagrams of FIGS. 5A-C. CRM 800 may pull or extract the power consumption and the application host transaction metrics in order to identify variations and anomalies, e.g., in certain relevant time periods, as described above in relation to operations 616 and 618 of FIG. 6A.

CRM 800 may store instructions 816 to generate a visual representation or a report indicating the correlated events, as described above in relation to operation 632 and 634 of FIG. 6B and the diagrams of FIGS. 5A-F.

CRM 800 may store instructions 818 to responsive to the visual representation or the report indicating an anomaly, allowing corrective actions addressing the indicated anomaly, as described above in relation to the operations of FIG. 6B.

CRM 800 may include more instructions than those shown in FIG. 8. For example, CRM 800 may store instructions for executing the operations described above in relation to: the high-level flow of FIG. 2; the log entry collection, formatting, transformation, and classification of FIGS. 3A-C; the environment and communications of FIG. 4; the diagrams of FIGS. 5A-F; the operations depicted in the flowcharts of FIGS. 6A and 6B; and instructions 718 of computer system 700 in FIG. 7.

Thus, the described aspects can provide improved anomaly detection across complex systems and enhanced root cause analysis capabilities. The described aspects can also provide more efficient identification of relationships between events in different sub-systems and more efficient handling of diverse log formats and event types. In addition, the described aspects can provide interactive user feedback for system optimization.

In general, the disclosed aspects provide a method, a computer system, and a computer-readable medium which facilitate smart log analytics for large-scale HPC and AI systems. During operation, the system obtains, from components operating jointly in a system, events information indicating a first set of events interpreted from log entries associated with the components and a second set of events returned from queries for standard events. The system classifies the events interpreted from log entries based on a hierarchy of the components. The system correlates two or more events based on a respective event classification and a predetermined time window covering an event time associated with a respective event, the event time derived from the log entries and the predetermined time window determined from measurements relating to power consumption, application run time, and transaction results associated with the components. The predetermined time window may also be obtained based on detection of errors and events across the components of the system, and this obtained time window may be used to search for application performance variations and anomalies in power. The system generates a visual representation indicating the correlated events. Responsive to the visual representation indicating an anomaly, the system allows corrective actions addressing the indicated anomaly.

In a variation on this aspect, the components comprise at least one of: hardware or software associated with storage components in the system; hardware or software associated with host components in the system, wherein the host components comprise one or more of a graphical processor unit (GPU), a high bandwidth memory (HBM), a central processing unit (CPU) or core, a CPU memory, and a peripheral component interconnect express (PCIe) component; or hardware or software associated with fabric components of the system, wherein the fabric components comprise one or more of a network device, a switch, a switch agent, a centralized fabric manager, a fabric agent, and a network interface.

In a further variation on this aspect, the system generates the log entries indicating the first set of events by: extracting logs from one or more of the components in the system; removing noise in the extracted logs by filtering the extracted logs; obtaining re-formatted log entries by re-formatting the filtered logs; and generating event information based on characteristics of the re-formatted log entries.

In a further variation, the characteristics of the re-formatted log entries comprise at least one of: identity of an entity or a component associated with the log entry; a time associated with an event which generated the log entry; an event category; an event type; or a description of the event.

In a further variation, the system stores information associated with the first and second sets of events in entries in a data structure and in a time series database, wherein a respective entry indicates the determined event classification and any correlations to other events.

In a further variation, the system queries the data structure for events associated with a first predetermined time period, wherein the first predetermined time period is based on at least one of: measurements relating to power consumption, application run time, and transaction results associated with the components; or detection of errors and events across the components of the system. The system correlates the queried events by marking respective entries for the queried events with a same correlation identifying tag. The system includes the correlated queried events in the generated visual representation.

In a further variation, the system generates a report based on the correlated events and displays the report. The system performs a first action based on the displayed report, wherein the first action comprises a respective corrective action addressing the indicated anomaly.

In a further variation, the displayed report includes one or more interactive elements facilitating viewing or manipulating the displayed information, including at least one of: a detected anomaly; a recommended action indicating remediation of the detected anomaly; or a configurable option indicating that the computer is to automatically perform the recommended action.

In another aspect, a computer system comprises a processor and a storage device storing instructions. The instructions are to obtain, from components operating jointly in a network environment, events information indicating a first set of events interpreted from log entries associated with the components and a second set of events returned from queries for standard events. The instructions are further to classify the events interpreted from log entries based on a topology of the components in the network environment. The instructions are further to store the log entries in a time series database. The instructions are further to correlate two or more events based on a respective event classification and a predetermined time window covering an event time associated with a respective event, wherein the event time is derived from the log entries and wherein the predetermined time window is determined from measurements relating to power consumption, application run time, and transaction results associated with the components. The instructions are further to generate a visual representation indicating the correlated events. The instructions are further to, responsive to the visual representation indicating an anomaly, allow corrective actions addressing the indicated anomaly. The computer system may include other instructions to perform the operations described herein, including in relation to: the high-level flow of FIG. 2; the log entry collection, formatting, transformation, and classification of FIGS. 3A-C; the environment and communications of FIG. 4; the diagrams of FIGS. 5A-F; the operations depicted in the flowcharts of FIGS. 6A and 6B; and the instructions of CRM 800 in FIG. 8.

In another aspect, a non-transitory computer-readable storage medium (or CRM) stores instructions to obtain, from components operating jointly in a system, events information indicating a first set of events interpreted from log entries associated with the components and a second set of events returned from queries for standard events. The instructions are further to classify the events interpreted from log entries based on a hierarchy of the components. The instructions are further to correlate two or more events based on a respective event classification and a predetermined time window covering an event time associated with a respective event, the event time derived from the log entries and the predetermined time window determined from measurements relating to power consumption, application run time, and transaction results associated with the components. The instructions are further to generate a visual representation or a report indicating the correlated events. The instructions are further to, responsive to the visual representation or the report indicating an anomaly, allowing corrective actions addressing the indicated anomaly. The CRM may also store instructions for executing the operations described above in relation to: the high-level flow of FIG. 2; the log entry collection, formatting, transformation, and classification of FIGS. 3A-C; the environment and communications of FIG. 4; the diagrams of FIGS. 5A-F; the operations depicted in the flowcharts of FIGS. 6A and 6B; and instructions 718 of computer system 700 in FIG. 7.

The foregoing description is presented to enable any person skilled in the art to make and use the aspects and examples, and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown, but are to be accorded the widest scope consistent with the principles and features disclosed herein.

Furthermore, the foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

What is claimed is:

1. A method, comprising:
obtaining, from components operating jointly in a system, events information indicating a first set of events interpreted from log entries associated with the components and a second set of events returned from queries for standard events;
classifying the events interpreted from log entries based on a hierarchy of the components;
correlating two or more events based on a respective event classification and a predetermined time window covering an event time associated with a respective event,
the event time derived from the log entries and the predetermined time window determined from measurements relating to power consumption, application run time, and transaction results associated with the components;
generating a visual representation indicating the correlated events; and
responsive to the visual representation indicating an anomaly, allowing corrective actions addressing the indicated anomaly.

2. The method of claim 1, wherein the components comprise at least one of:
hardware or software associated with storage components in the system;
hardware or software associated with host components in the system, wherein the host components comprise one or more of a graphical processor unit (GPU), a high bandwidth memory (HBM), a central processing unit (CPU) or core, a CPU memory, and a peripheral component interconnect express (PCIe) component; or
hardware or software associated with fabric components of the system, wherein the fabric components comprise one or more of a network device, a switch, a switch agent, a centralized fabric manager, a fabric agent, and a network interface.

3. The method of claim 1, further comprising generating the log entries indicating the first set of events by:
extracting logs from one or more of the components in the system;
removing noise in the extracted logs by filtering the extracted logs;
obtaining re-formatted log entries by re-formatting the filtered logs; and
generating event information based on characteristics of the re-formatted log entries.

4. The method of claim 3, wherein the characteristics of the re-formatted log entries comprise at least one of:
identity of an entity or a component associated with the log entry;
a time associated with an event which generated the log entry;
an event category;
an event type; or
a description of the event.

5. The method of claim 1, further comprising:
storing information associated with the first and second sets of events in entries in a data structure and in a time series database, wherein a respective entry indicates the determined event classification and any correlations to other events.

6. The method of claim 5, further comprising:
querying the data structure for events associated with a first predetermined time period, wherein the first predetermined time period is based on at least one of:
measurements relating to power consumption, application run time, and transaction results associated with the components; or
detection of errors and events across the components of the system;
correlating the queried events by marking respective entries for the queried events with a same correlation identifying tag; and
including the correlated queried events in the generated visual representation.

7. The method of claim 1, further comprising:
generating a report based on the correlated events;
displaying the report; and
performing a first action based on the displayed report,
wherein the first action comprises a respective corrective action addressing the indicated anomaly.

8. The method of claim 7,
wherein the displayed report includes one or more interactive elements facilitating viewing or manipulating the displayed information, including at least one of:
a detected anomaly;
a recommended action indicating remediation of the detected anomaly; or
a configurable option indicating that the computer is to automatically perform the recommended action.

9. A computer system, comprising:
a processor; and
a storage device storing instructions which when executed by the processor comprise instructions to:
obtain, from components operating jointly in a network environment, events information indicating a first set of events interpreted from log entries associated with the components and a second set of events returned from queries for standard events;
classify the events interpreted from log entries based on a topology of the components in the network environment;
correlate two or more events based on a respective event classification and a predetermined time window covering an event time associated with a respective event,
wherein the event time is derived from the log entries and wherein the predetermined time window is determined from measurements relating to power consumption, application run time, and transaction results associated with the components;
generate a visual representation indicating the correlated events; and
responsive to the visual representation indicating an anomaly, allow corrective actions addressing the indicated anomaly.

10. The computer system of claim 9, wherein the components comprise at least one of:
hardware or software associated with storage components in the network environment;
hardware or software associated with host components in the network environment, wherein the host components comprise one or more of a graphical processor unit (GPU), a high bandwidth memory (HBM), a central processing unit (CPU) or core, a CPU memory, and a peripheral component interconnect express (PCIe) component; or
hardware or software associated with fabric components of the network environment, wherein the fabric components comprise one or more of a network device, a switch, a switch agent, a centralized fabric manager managing switches in the fabric, a fabric agent operating on a switch, wherein the fabric agent programs the switch and interacts with network protocol agents, and a network interface.

11. The computer system of claim 9, the instructions further to:
extract logs from one or more of the components in the network environment;
remove noise in the extracted logs by filtering the extracted logs;
obtain re-formatted log entries by re-formatting the filtered logs; and
generate event information based on characteristics of the re-formatted log entries.

12. The computer system of claim 11, wherein the characteristics of the re-formatted log entries comprise at least one of:
identity of an entity or a component associated with the log entry;
a time associated with an event which generated the log entry;
an event category;
an event type; or
a description of the event.

13. The computer system of claim 9, the instructions further to:
store information associated with the first and second sets of events in entries in a data structure and in a time series database, wherein a respective entry indicates the determined event classification and any correlations to other events.

14. The computer system of claim 13, the instructions further to:
query the data structure for events associated with a first predetermined time period, wherein the first predetermined time period is based on measurements relating to power consumption, application run time, and transaction results associated with the components;
correlate the queried events by marking respective entries for the queried events with a matching correlation tag; and
include the correlated queried events in the generated visual representation.

15. The computer system of claim 9, the instructions further to:
generate a report based on the correlated events;
displaying the report; and
perform a first action based on the displayed report,
wherein the first action comprises a respective corrective action addressing the indicated anomaly.

16. The computer system of claim 15,
wherein the displayed report includes one or more interactive elements facilitating viewing or manipulating the displayed information, including at least one of:
a detected anomaly;
a recommended action indicating remediation of the detected anomaly; or
a configurable option indicating that the computer is to automatically perform the recommended action.

17. The computer system of claim 15, the instructions further to:
responsive to allowing the corrective actions addressing the anomaly indicated in the visual representation or performing the first action based on the displayed report:
obtain updated events information from the components;
classify updated events indicated in the updated events information;
correlate two or more events based on the updated events, a respective event classification, and the predetermined time window;
re-generate the visual representation indicating the correlated events; and
responsive to the re-generated visual representation indicating one or more other anomalies, allow further corrective actions addressing the one or more other anomalies.

18. A non-transitory computer-readable medium storing instructions to:
obtain, from components operating jointly in a system, events information indicating a first set of events interpreted from log entries associated with the components and a second set of events returned from queries for standard events;
classify the events interpreted from log entries based on a hierarchy of the components;
correlate two or more events based on a respective event classification and a predetermined time window covering an event time associated with a respective event, the event time derived from the log entries and the predetermined time window determined from measurements relating to power consumption, application run time, and transaction results associated with the components;
generate a visual representation or a report indicating the correlated events; and
responsive to the visual representation or the report indicating an anomaly, allowing corrective actions addressing the indicated anomaly.

19. The non-transitory computer-readable medium of claim 18, the instructions further to generate the log entries indicating the first set of events by:
extracting logs from one or more of the components in the system;
removing noise in the extracted logs by filtering the extracted logs;
obtaining re-formatted log entries by re-formatting the filtered logs; and
generating event information based on characteristics of the re-formatted log entries.

20. The non-transitory computer-readable medium of claim 18, the instructions further to:
display the visual representation or the report,
wherein the displayed visual representation or the report includes one or more interactive elements facilitating viewing or manipulating displayed information,
wherein the displayed information includes at least one of:
a detected anomaly;
a recommended action indicating remediation of the detected anomaly; or
a configurable option indicating that the computer is to automatically perform the recommended action; and
responsive to allowing the corrective actions addressing the indicated anomaly:
obtain updated events information from the components;
classify updated events indicated in the updated events information;
correlate two or more events based on the updated events, a respective event classification, and the predetermined time window;
re-generate the visual representation indicating the correlated events; and
responsive to the re-generated visual representation indicating one or more other anomalies, allow further corrective actions addressing the one or more other anomalies.
